(19) United States
(12) Patent Application Publication
(10) Pub. No.: US 2024/0428003 A1
(43) Pub. Date: Dec. 26, 2024

(54) AUTOMATIC CONTENT ITEM UPDATION BASED ON COMPUTER-MEDIATED INTERACTION

(71) Applicant: Google LLC, Mountain View, CA (US)

(72) Inventors: Swarna Srinivas Kakodkar, Bethlehem, PA (US); Arpita Saha, Mountain View, CA (US)

(73) Assignee: Google LLC, Mountain View, CA (US)

(21) Appl. No.: 18/340,414

(22) Filed: Jun. 23, 2023

(51) Int. Cl. G06F 40/35; G06Q 30/015

(52) U.S. Cl. CPC G06F 40/35; G06Q 30/015

(57) ABSTRACT

Implementations described herein relate to methods, devices, and computer-readable media to automatically modify a content item based on computer-mediated interaction with reference to a content item. The method includes programmatically analyzing the computer-mediated interaction between a user and a customer service agent to determine if the computer-mediated interaction is successful. The method further includes identifying information provided by the customer service agent during the computer-mediated interaction. The method further includes generating a content update based on the identified information. The method further includes modifying the content item based on the content update.

### BACKGROUND

Users refer to help articles, e.g., to understand how to use a hardware or a software product; to resolve problems when using the hardware or software product; etc. A help article may sometimes not help the user understand how to use a product. Further, a user may not be able to resolve problems by referring to a help article. A user may contact a customer service agent to obtain further help and guidance. Such interactions may be mediated by a computer, e.g., performed online via text, audio, or video chat.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to methods, devices, and computer-readable media to automatically modify a content item based on computer-mediated interaction between a user and a customer service agent.

Some implementations include a computer-implemented method to automatically modify a content item. The method includes programmatically analyzing computer-mediated interaction between a user and a customer service agent to determine if the computer-mediated interaction is successful, wherein the computer-mediated interaction is with reference to the content item. The method further includes identifying information provided by the customer service agent during the computer-mediated interaction. The method further includes generating a content update based on the identified information and modifying the content item based on the content update.

In some implementations, programmatically analyzing the computer-mediated interaction is performed in response to determining that a rating associated with the content item is below a threshold. In some implementations, determining that the rating associated with the content item is below the threshold includes determining that a contact rate of customers to a customer service center for support after views of the content item by the customers is higher than a predetermined rate.

In some implementations, the computer-mediated interaction includes a call, a synchronous chat, or asynchronous interaction. In some implementations, programmatically analyzing the computer-mediated interaction includes detecting a user sentiment during the computer-mediated interaction based on text, speech, or video of the user. In some implementations, the interaction is determined to be successful if the user sentiment at an endpoint of the computer-mediated interaction meets a threshold. In these implementations, identifying information provided by the customer service agent includes identifying a subset of text, speech, or video of the customer service agent near a time during the computer-mediated interaction at which the user sentiment changes from below the threshold to above the threshold. The subset of text, speech, or video can include a link to a second content item. In some implementations, generating the content update includes generating text with the link to the second content item. In some implementations, modifying the content item includes inserting the text with the link to the second content item in the content item.

In some implementations, the content item includes one or more of item text, item audio, or item video. In some implementations modifying the content item comprises determining an insertion point for the additional content.

In some implementations, the content item is a help article and the computer-mediated interaction is with reference to a user interface of a software product. In these implementations, the information provided by the customer service agent may include a screenshot or a video of the user interface of the software product. In these implementations, the content update includes the screenshot or the video.

In some implementations, the method may further include displaying the content update to the customer service agent and receiving confirmation of the content update from the customer service agent. In these implementations, modifying the content item is performed in response to receiving the confirmation.

In some implementations, the method may further include determining that the information provided by the customer service agent during the computer-mediated interaction is from a third content item In these implementations generating the content update includes one or more of merging the content item with the third content item, inserting a link to the third content item in the content item, or replacing a portion of the content item with a portion of the third content item.

Some implementations include a computing device comprising a processor and a memory coupled to the processor, with instructions stored thereon that, when executed by the processor, cause the processor to perform operations that include programmatically analyzing computer-mediated interaction between a user and a customer service agent to determine if the computer-mediated interaction is successful, wherein the computer-mediated interaction is with reference to a content item, identifying information provided by the customer service agent during the computer-mediated interaction, generating a content update based on the identified information, and modifying the content item based on the content update. In some implementations, programmatically analyzing the computer-mediated interaction is performed in response to determining that a rating associated with the content item is below a threshold. In some implementations, determining that the rating associated with the content item is below the threshold comprises determining that a contact rate of customers to a customer service center for support after views of the content item by the customers is higher than a predetermined rate. In some implementations, programmatically analyzing the computer-mediated interaction includes detecting a user sentiment during the computer-mediated interaction based on one or more of: text, speech, or video of the user. In some implementations, the operations may further include displaying the content update to the customer service agent and receiving confirmation of the content update from the customer service agent. In these implementations, modifying the content item is performed in response to receiving the confirmation.

Some implementations include a non-transitory computer-readable medium with instructions stored thereon that, when executed by a processor, cause the processor to perform operations that include programmatically analyzing computer-mediated interaction between a user and a customer service agent to determine if the computer-mediated interaction is successful, wherein the computer-mediated interaction is with reference to a content item, identifying information provided by the customer service agent during the computer-mediated interaction, generating a content update based on the identified information, and modifying the content item based on the content update. In some implementations, programmatically analyzing the computer-mediated interaction is performed in response to determining that a rating associated with the content item is below a threshold. In some implementations, determining that the rating associated with the content item is below the threshold includes determining that a contact rate of customers to a customer service center for support after views of the content item by the customers is higher than a predetermined rate. In some implementations, programmatically analyzing the computer-mediated interaction includes detecting a user sentiment during the computer-mediated interaction based on one or more of: text, speech, or video of the user.

### BRIEF DESCRIPTION OF THE DRAWINGS

FIG. 1 is a block diagram of an example network environment which may be used for one or more implementations described herein.

FIG. 2 is a block diagram illustrating an example method to XXX, according to some implementations.

FIG. 3 is a diagram illustrating an example of computer-mediated interaction between a user and a customer service agent.

FIGS. 4A-4C each illustrate an example of a content item.

FIG. 5 illustrates an example of a modified content item.

FIG. 6 a block diagram of an example device which may be used for one or more implementations described herein.

### DETAILED DESCRIPTION

Many providers of physical appliances, computing devices, software applications, or other products provide online content, such as help articles, how-to videos, problem diagnosis guidelines, step-by-step instructions, etc. for their products. Some providers also implement online customer support to enable a customer to interact with a customer service agent, e.g., via text chat, audio, and/or video. Providing interactive support can be expensive and may require the provider to implement customer support systems via hardware and software, and to recruit human customer service agents. High quality content items can reduce the rate at which customers contact customer support and can thereby reduce the cost of provision.

Writing high quality content currently requires human effort. In particular, human authors such as product engineers, technical writers, etc. need to spend time understanding the various features of a product and describing how to use those (in text, audio, or video). Further, such authors need to determine customer needs for support regarding a product and write content accordingly. Also, many hardware and software products receive periodic updates from the provider, or have a large number of variations (e.g., different sizes, different configurations, less or more features and corresponding hardware or code, etc.) requiring content to be customized for each update or variation.

Various techniques described herein automate the generation and update of content items. With appropriate permissions, computer-mediated interaction between a customer and a customer service agent are automatically analyzed. The customer intent (e.g., solve a problem related to a product, learn to use a product feature, etc. is automatically determined. The customer sentiment during and after the interaction is identified and utilized to determine whether an interaction was successful. Successful interactions are analyzed to automatically generate a content update. The content update may be inserted into a content item or may be provided as a new content item. The techniques can be utilized to improve the speed at which content items are updated (by eliminating human effort to write), the quality of updates, and the coverage of product features in the content items.

The described techniques can reduce the computational cost of deploying customer support resources by reducing the call rate to the customer support center based on improved availability and quality of the content items. The described techniques can reduce computational costs for various customers, by reducing the need to engage in computer-mediated interaction.

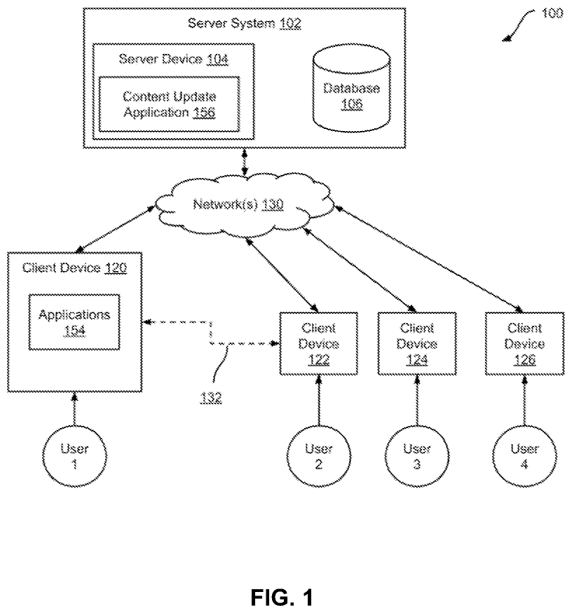

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104 and a database 106 or other storage device. In some implementations, server device 104 may provide a content update application 156.

Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication between devices, e.g., using peer-to-peer wireless protocols (e.g., Bluetooth®, Wi-Fi Direct, etc.), etc. One example of peer-to-peer communications between two client devices 120 and 122 is shown by arrow 132.

For ease of illustration, FIG. 1 shows one block for server system 102, server device 104 and database 106, and four blocks for client devices 120, 122, 124, and 126. Server blocks 102, 104, and 106 may represent multiple systems, server devices, and network databases, and the blocks can be provided in different configurations than shown. For example, server system 102 can represent multiple server systems that can communicate with other server systems via the network 130. In some implementations, server system 102 can include cloud hosting servers, for example. In some examples, database 106 and/or other storage devices can be provided in server system block(s) that are separate from server device 104 and can communicate with server device 104 and other server systems via network 130.

Also, there may be any number of client devices. Each client device can be any type of electronic device, e.g., desktop computer, laptop computer, portable or mobile device, cell phone, smart phone, tablet computer, television, TV set top box or entertainment device, wearable devices (e.g., display glasses or goggles, wristwatch, headset, armband, jewelry, etc.), personal digital assistant (PDA), media player, game device, etc. Some client devices may also have a local database similar to database 106 or other storage. In some implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., a social network service or other type of network service, implemented on server system 102. For example, respective client devices 120, 122, 124, and 126 may communicate data to and from one or more server systems (e.g., system 102).

In some implementations, the server system 102 may provide appropriate data to the client devices such that each client device can receive communicated content or shared content uploaded to the server system 102 and/or network service. In some examples, users U1-U4 can interact via audio or video conferencing, audio, video, or text chat, or other communication modes or applications.

A network service implemented by server system 102 can include a system allowing users to perform a variety of communications, form links and associations, upload and post shared content such as images, text, video, audio, and other types of content, and/or perform other functions. For example, a client device can display received data such as content posts sent or streamed to the client device and originating from a different client device via a server and/or network service (or from the different client device directly), or originating from a server system and/or network service. In some implementations, client devices can communicate directly with each other, e.g., using peer-to-peer communications between client devices as described above. In some implementations, a “user” can include one or more programs or virtual entities, as well as persons that interface with the system or network.

In some implementations, any of client devices 120, 122, 124, and/or 126 can provide one or more applications. For example, as shown in FIG. 1, client device 120 may provide applications 154. Client devices 122-126 may also provide similar applications.

In some implementations, applications 154 may be applications that provide various types of functionality, e.g., calendar, address book, e-mail, web browser, shopping, transportation (e.g., taxi, train, airline reservations, etc.), entertainment (e.g., a music player, a video player, a gaming application, etc.), social networking (e.g., messaging or chat, audio/video calling, sharing images/video, etc.) and so on. In some implementations, one or more of other applications 154 may be standalone applications that execute on client device 120. In some implementations, one or more of applications 154 may access a server system, e.g., server system 102, that provides data and/or functionality of applications 154.

A user interface on a client device 120, 122, 124, and/or 126 can enable the display of user content and other content, including images, video, data, and other content as well as communications, privacy settings, notifications, and other data. Such a user interface can be displayed using software on the client device, software on the server device, and/or a combination of client software and server software executing on server device 104, e.g., application software or client software in communication with server system 102. The user interface can be displayed by a display device of a client device or server device, e.g., a touchscreen or other display screen, projector, etc. In some implementations, application programs running on a server system can communicate with a client device to receive user input at the client device and to output data such as visual data, audio data, etc. at the client device.

In various implementations, any of client devices 120-126 may be used by a user and/or a customer service agent (e.g., a human customer service agent). In some implementations, server system 102 may implement an automated customer service agent (e.g., a chatbot or other automated agent trained for customer interaction). In various implementations, a user of a client device may interact with a customer service agent via appropriate software, e.g., a dedicated customer support application (e.g., one of applications 154), a browser-based application (e.g., a chat or video-calling service), etc. In some implementations, the computer-mediated interaction may include a telephone call between the user (e.g., where a client device 120-126 is a telephone) and a customer service agent.

In some implementations, the computer-mediated interaction may be a text, audio, or video chat. The interaction can take place over network 130 that enables exchange of content between the user and the customer service agent.

In some implementations, database 106 may store content items. In various implementations, content items may include help articles that include text, audio, video, images, or any combination thereof. Users of client devices 120-126 may access the content items over the network 130.

Content update application 156 on server device 104 may include various features. In some implementations, content update application 156 may determine a contact rate (the rate at which a user contacts a customer service agent) for individual content items. For example, the contact rate may be determined based on programmatic analysis (e.g., using machine learning, text/audio parsing, speech to text, etc.) to determine one or more content items with reference to which computer-mediated interaction takes place.

In some implementations, content update application 156 may, with user permission, programmatically analyze the computer-mediated interaction to determine whether the interaction was successful (e.g., based on user sentiment or explicit feedback). In some implementations, content update application 156 may generate a content update based on the computer-mediated interaction and modify one or more content items in database 106 to include the content update. In some implementations, determining contact rate, determining whether an interaction is successful, and modifying content items may be performed by different applications.

Other implementations of features described herein can use any type of system and/or service. For example, other networked services (e.g., connected to the Internet) can be used instead of or in addition to a social networking service. Any type of electronic device can make use of features described herein. Some implementations can provide one or more features described herein on one or more client or server devices disconnected from or intermittently connected to computer networks. In some examples, a client device including or connected to a display device can display content posts stored on storage devices local to the client device, e.g., received previously over communication networks.

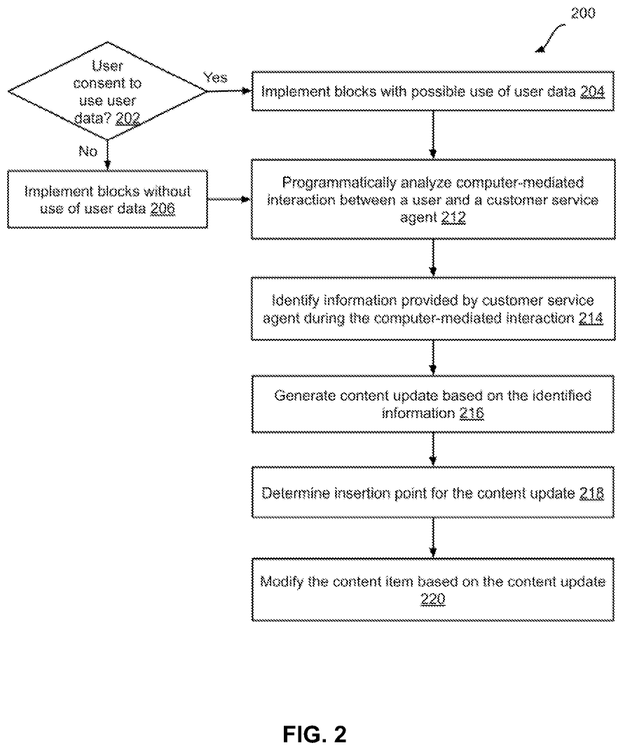

FIG. 2 is a flow diagram illustrating an example method 200 to modify a content item, according to some implementations. In some implementations, method 200 can be implemented, for example, on a server system 102 as shown in FIG. 1. In some implementations, some or all of the method 200 can be implemented on one or more client devices 120, 122, 124, or 126 as shown in FIG. 1, one or more server devices, and/or on both server device(s) and client device(s). In described examples, the implementing system includes one or more digital processors or processing circuitry (“processors”), and one or more storage devices (e.g., a database 106 or other storage). In some implementations, different components of one or more servers and/or clients can perform different blocks or other parts of the method 200. In some examples, a first device is described as performing blocks of method 200. Some implementations can have one or more blocks of method 200 performed by one or more other devices (e.g., other client devices or server devices) that can send results or data to the first device.

In some implementations, the method 200, or portions of the method, can be initiated automatically by a system. In some implementations, the implementing system is a first device. For example, the method (or portions thereof) can be periodically performed, or performed based on one or more particular events or conditions, e.g., a computer-mediated interaction being initiated or closed, a contact rate for a customer service center meeting a threshold, a new product or a new version of a product being launched, a predetermined time period having expired since the last performance of method 200, and/or one or more other conditions occurring which can be specified in settings read by the method.

Method 200 may begin at block 202. At block 202, it is checked whether user consent (e.g., user permission) has been obtained to use user data in the implementation of method 200. For example, user data can include user interaction data, e.g., a clickstream; user's interaction with a customer service agent (e.g., a human agent, an automated bot, or a combination); user's device characteristics (e.g., device type, device operating system, operating system version, applications available on the device and their versions, etc.); a user's identity (e.g., role within a corporation that employs the user); a user's location (e.g., office location that the user works at); historical user data such as usage patterns associated with software applications on a user computing device (e.g., including the nature of interaction such as short clicks, long clicks, scrolling portions of an article, etc.), search history, content items such as help articles, videos, etc. that the user interacted with etc. One or more blocks of the methods described herein may use such user data in some implementations.

If user consent has been obtained from the relevant users for which user data may be used in the method 200, then in block 204, it is determined that the blocks of the methods herein can be implemented with possible use of user data as described for those blocks, and the method continues to block 210. If user consent has not been obtained, it is determined in block 206 that blocks are to be implemented without the use of user data, and the method continues to block 210. In some implementations, if user consent has not been obtained, blocks are implemented without the use of user data and with synthetic data and/or generic or publicly-accessible and publicly-usable data. In some implementations, if user consent has not been obtained, the rest of method 200 is not performed.

At block 212, computer-mediated interaction between a user and a customer service agent is programmatically analyzed. For example, the computer-mediated interaction may be via text (e.g., via a messaging application, via email, or other messaging service), via audio (e.g., as a telephone call, a Voice over IP (VoIP) call, etc.), via video (e.g., a video call), etc. Any combination of text, audio, and/or video may be utilized. In various implementations the computer-mediated interaction may be a call, a synchronous chat (audio and/or video), or asynchronous interaction. For example, asynchronous interaction may include a user registering a complaint or ticket (e.g., “I don't see the option listed in article H; cannot download a file”) via a customer support system and in response, the customer service agent engaging in asynchronous interaction (e.g., back-and-forth correspondence via the customer support system, via email, etc.) with the user.

In some implementations, the programmatically analyzing may be performed offline, e.g., after the computer-mediated interaction is complete. In some implementations, the programmatically analyzing may be performed substantially in real-time, e.g., while the interaction is in progress.

Programmatically analyzing the computer-mediated interaction may be performed using any suitable techniques, such as a text parser (that can determine sentiment from text, can identify entities within text, etc.), an audio parser (e.g., that directly determines sentiment based on audio content, including voice characteristics; identifies entities, and other information from audio) or a speech-to-text (STT) technique followed by a text parser; a video analysis engine (e.g., that can detect sentiment based on facial expression, that can detect entities from the video, e.g., from a live screen-share or images/videos exchanged between the user and the customer service agent), etc. In various implementations, such analysis may be performed by one or more suitably trained machine learning models.

In various implementations, machine learning (ML) and/or natural language processing (NLP) techniques may be used to analyze conversation patterns. For example, such techniques may be utilized to determine the intent of the customer engaging in the computer-mediated interaction (e.g., a customer support request to learn to perform a particular action via a software application, to diagnose a problem the customer is experiencing, to set up a new device and/or software application, to update a device or application configuration, etc.). Based on the determined intent, the interaction may be identified as belonging to a particular category (or set of categories). In some implementations, generating artificial intelligence, e.g., large language models (LLMs) or other techniques may be utilized to generate a conversation summary (e.g., a single summary, or a summary divided into segments), which may in turn be used to identify a potential solution (e.g., a content item that addresses the user's intent). In some implementations, a similarity between the customer request (e.g., a first segment) and agent response (e.g., a second segment, subsequent to the first segment) may be computed. The similarity computation may be utilized in mapping the solutions suggested by the agent (e.g., to available content items) and in the automatic generation and/or modification of content items.

Programmatic analysis of the computer-mediated interaction may identify one or more entities that are a subject of the interaction. In various examples, the entities may include a content item with reference to which the interaction is (e.g., a help article, a how-to video, audio instructions, etc.); a device type of the user device; a device version and operating system of the device; one or more applications on the device; an identity of the user for example a corporate login name or role (e.g., that maps to a software application-specific identity of the user); a division or section of a corporation that the user belongs to; a location of the user; or any other information provided by the user or the customer service agent during the interaction. and some implementations identification of the one or more entities may be performed using a machine learning model trained for entity detection. In some implementations the machine learning model may be trained based on a predetermined set of entities. For example, such entities may be identified by the corporation that provides the customer service.

In some implementations programmatic analysis may include sentiment detection for example whether the user is satisfied with the interaction. For example, sentiment detection may be performed based on text analysis (e.g., detecting positive words or phrases or lack thereof; detecting negative words or phrases; etc.), audio analysis (e.g., determining user sentiment based on tone, pitch, or other voice characteristics) and/or video analysis (e.g., determining sentiment based on facial expression, including eye expression). In some implementations, techniques such as natural language understanding (NLU), sentiment analysis, etc. may be utilized. In some implementations, one or more large language models (LLMs) may be utilized to build a semantic understanding of the computer-mediated interaction, e.g., from a text transcript and/or audio/video of the computer-mediated interaction.

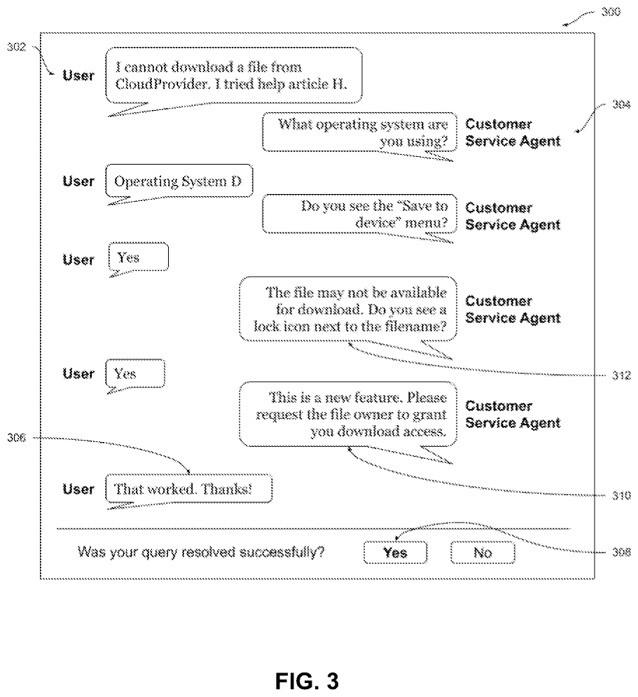

FIG. 3 illustrates an example 300 of computer-mediated interaction between a user and a customer service agent. As illustrated in FIG. 3, a user 302 chats with a customer service agent 304. For ease of illustration, the interaction is shown as a text chat; however, the computer-mediated interaction may include audio and/or video. In the example illustrated in FIG. 3 the interaction is with reference to the user having difficulties downloading a file from a cloud provider and having tried a help article H. The entities “CloudProvider” and “Help Article H” (which is a content item) may be detected from the first message. As the interaction proceeds, one or more additional entities may be detected. In the example of FIG. 3 such entities include operating system D, the “save to device” menu, “lock icon”, etc.

Still further, user sentiment may be detected based on one or more messages in the computer-mediated interaction. In the example illustrated in FIG. 3, it may be determined that the user sentiment is “happy” and/or that the interaction was successful based on the last message (306) from the user (“That worked. Thanks!”). In some implementations the computer mediated interaction may include explicit user feedback regarding whether the interaction was successful or not. In the example illustrated in FIG. 3, the user has confirmed that their query was resolved successfully by picking the “Yes” option (308).

In some implementations, the programmatically analyzing may be performed for all user-permitted interactions. In some implementations, the programmatically analyzing may include first determining that the computer-mediated interaction is with reference to a particular content item. In these implementations, further programmatic analysis (e.g., determining user sentiment, determining if the interaction was successful, etc.) is performed in response to determining that a rating associated with the content item is below a threshold.

In some implementations, determining that the rating associated with the content item is below the threshold is based on a contact rate of prior customers. For example, if a rate at which customers contact a customer service center for support (e.g., for their product) after viewing the content item is higher than a predetermined rate, the rating associated with the content item may be determined to be low (e.g., lower than the threshold). For example, if the content item is a help article or video about a product (e.g., how to navigate a user interface to download a file) and at least a threshold proportion of users (e.g., 10%, 30%, etc.) call the customer service center after viewing the content item, it may be determined that the content item is unsatisfactory. In these implementations, programmatically analyzing the computer-mediated interaction is performed.

On the other hand, if a content item has a low contact rate (few users contact the customer service center), it may be determined that the content item is performing satisfactorily (because the content item addresses the user's query) and further programmatic analysis of the computer-mediated interaction is not performed, thus saving computational resources. Further, if a content item has a low rate of user interaction, e.g., customers don't view the content item, view it for a very short duration (less than a threshold time) determined based on short clicks or other interaction data, or fewer than a threshold number of customers view the content item, the content item may be determined as unsatisfactory. An unsatisfactory content item may be due to a content quality problem (the content item does not fulfill customer needs) or due to a content discovery problem (e.g., the content item is not identified in response to customer queries, due to poor keywords, low quality search index, or other issues). Block 212 may be followed by block 214.

At block 214, information provided by the customer service agent during the computer-mediated interaction is identified. In case of a successful interaction (determined based on sentiment detection and/or explicit user feedback), such information may be determined to potentially be useful to other users. In some implementations, identifying information provided by the customer service agent includes identifying a subset of text, speech, or video of the customer service agent near a time during the computer-mediated interaction at which the user sentiment changes from below the threshold to above the threshold.

In the example illustrated in FIG. 3, the user sentiment prior to message 306 is determined to be below the threshold, while at 306, the sentiment exceeds the threshold, based on the user's message including the positive phrase “that worked” and the acknowledgement of the customer service agent (“Thanks!”). In this example, message 310 from the customer service agent is identified as the subset that is near the time at which the user sentiment changes. It is determined that the information “Please request the file owner to grant you download access” may likely be a solution to the query that the user had. Further, the message 312 “The file may not be available for download, do you see a lock icon next to the filename?” may be determined as information provided by the customer service agent. Other messages from the customer service agent and/or the user, e.g., the user's operating system (“Operating System D”), that the user is able to see the “Save to device” menu, etc. may also be identified as additional information.

In some implementations, the user sentiment may be gathered at the end of an interaction via an explicit question. For example, a question “Was your query resolved successfully?” is included and the user's selection of “Yes” (308) is an indication that the user's sentiment is positive and exceeds the threshold. Block 214 may be followed by block 216.

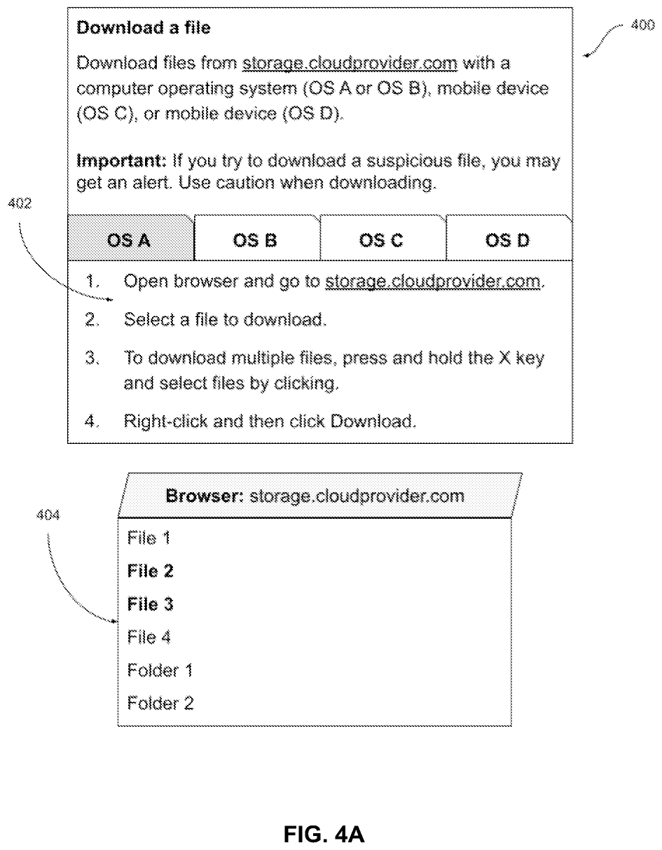

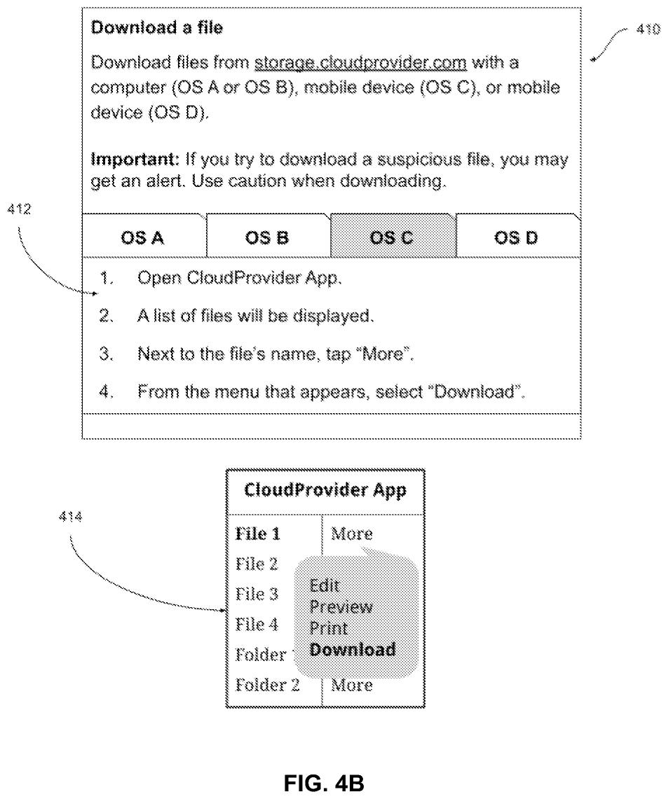

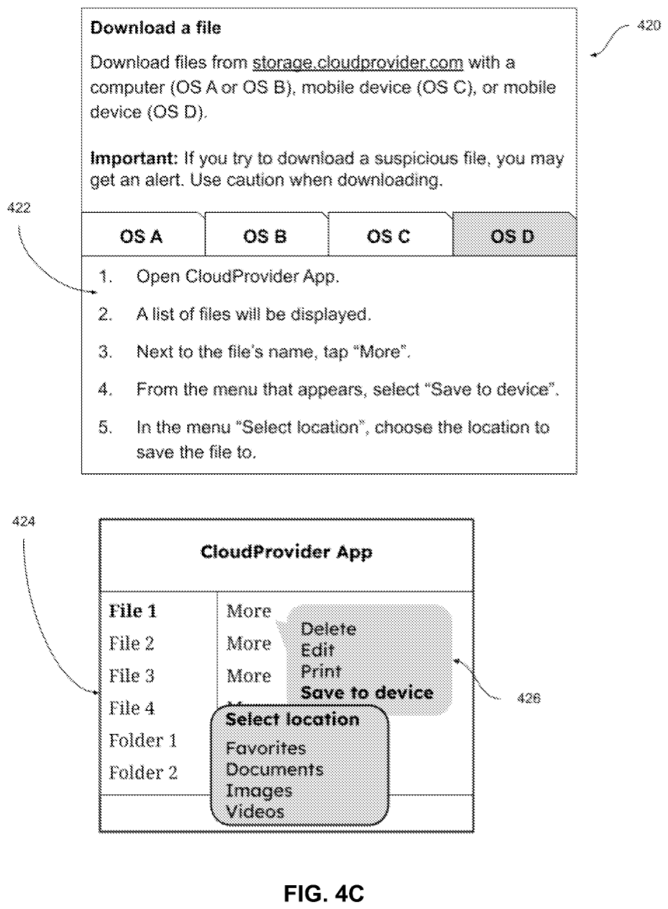

At block 216, a content update is generated based on the identified information. FIGS. 4A-4C each illustrate an example of a content item. In the examples of FIG. 4A-4C, the content item is a help article that provides the user instructions on how to download a file from storage provided by a cloud provider. As the storage may be accessed by users using devices that run different operating systems (OS A, OS B, OS C, and OS D), the content item is partitioned into four sections (shown as tabbed sections in each of FIG. 4A-4C).

As seen in FIG. 4A, for operating system A, the instructions (402) in the content item instructed the user to use a browser to perform the download. A screenshot or video grab (404) of an example browser is also included in the content item to provide visual guidance to the user.

As seen in FIG. 4B, for operating system C, the instructions (412) in the content item instruct the user to use a native app (CloudProvider App). A screenshot or video grab (414) of the app interface on OS C is also included in the content item to provide visual guidance to the user.

In FIG. 4C, for operating system D, the instructions (422) in the content app to use the native app are different from instructions (412) for operating system C. Further, the screenshot or video 424 reflects the different native user interface of OS D. The screenshot includes a menu 426 that illustrates the user interaction. During interaction, with user permission, the operating system used by the user may be detected to automatically present the appropriate section to the user.

As seen in FIG. 4A-4C, the content items as described herein can adapt to a user. For example, display of the content items may be customized based on user-permitted contextual factors, e.g., the user's device type, device operating system (e.g., to select a particular section of content item based on the OS, to show one of 400, 410, or 420). Further, automatic detection of contextual factors can be utilized to tailor the content item, e.g., to show text-only content for a low bandwidth connection, to emphasize video content for a user connecting from a device with a screen but to present audio-only content for a device without a screen (e.g., a smart speaker).

Based on a successful interaction between a user and a customer service agent, a content update may be generated based on the identified information. In some implementations, the content update may be performed in response determining that a threshold number of successful interactions included similar information. In some implementations, the threshold number may be selected based on a contact rate of customers after views of the content item (e.g., a high contact rate may correspond to a lower threshold number to ensure a faster update rate). In some implementations, the content update may be generated and displayed in response to input by the customer service agent, e.g., the customer service agent may be provided an option to generate and preview a content update based on detecting a successful interaction.

In some implementations, the content update may be generated using machine learning techniques. For example, a text generation or transformation tool, such as a generative model may be utilized to generate text based on the identified information. For example, based on the identified information (310 and 312), text that includes text instructions regarding the “save to device” menu and requesting the file owner to grant access may be generated.

In some implementations, the content update is generated based on the computer-mediated interaction, e.g., a conversation transcript of the conversation between the customer and the agent. In some implementations, generative artificial intelligence (e.g., LLM or other techniques) may be utilized to transform the conversation (e.g., conversational turns where a customer asks a question and an agent responds, or a summary thereof) into instructions, e.g., step-by-step instructions. The LLM or other model may be trained using user-permitted data from prior customer support interactions and groundtruth content items that addressed the customer request in such interactions. Training of the model can be performed using a suitable technique such as prompt tuning or fine tuning. In some implementations, the training may be performed using reinforcement learning with human feedback (RLHF) technique. The generated content update may include text, image, audio, video, or a combination. For example, generative AI may be utilized to generate an instruction sequence as text, as a flow diagram illustrating each step in the instruction sequence, as audio with step-by-step guidance, or as a video (e.g., including screenshots from the software application) with audio/text instructions.

In some implementations, a subset of the text, speech, or video provided by the customer service agent may be utilized to generate the content update. In some implementations, the subset of text, speech, or video includes a link to a second content item (e.g., provided by the customer service agent. In these implementations, generating the content update may include generating text with the link to the second content item. Block 216 may be followed by block 218.

At block 218, an insertion point for the content update is determined. The content update may be added to the content item with reference to which the computer-mediated interaction takes place. To determine the insertion point, the content item and the content update may be analyzed to identify a suitable location. Insertion point in the case of a text update may correspond to a spatial layout where the content update follows prior text in the content item. In case of an audio or video content update, the insertion point may be a suitable frame of the audio or video after which the content update can be inserted.

In some implementations, the insertion point may be determined based on categorizing a customer intent and/or based on a generated title of the content update. For example, the intent and/or title may be compared with existing sections of the content item (e.g., the titles and/or associated intent, which may be pre-stored or determined using a LLM or other technique). The insertion point for the content update is determined based on the comparison. For example, if the content item is about logging into a software application, and the content update is about “password reset,” the content update is inserted after the “create a password” section, since a password reset can only take place if the user has an existing password. In some implementations, human review of the updated content item may be performed and edits made by the human reviewer may be provided as feedback to update a machine learning model that generates content updates. In some implementations, the generated content item may be provided to a subset of customers and its performance evaluated, prior to being made available to all customers. Block 218 may be followed by block 220.

At block 220, the content item is modified (e.g., the content update is added to a pre-existing content item). For example, the modifying may include inserting the content item in the content item at the insertion point (if determined) or at another suitable point (e.g., at the beginning, at the end, etc.). In some implementations, the content update may be utilized to generate a new content item, e.g., when no content item exists that has a suitable insertion point for the content update.

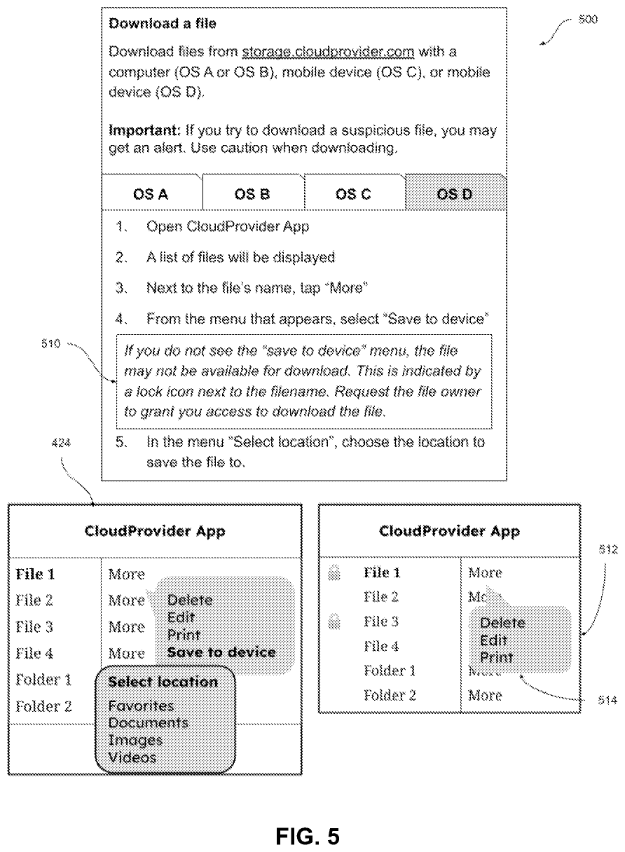

FIG. 5 illustrates an example of a modified content item 500. The content item 500 of FIG. 5 is a modified version of the content item 420 of FIG. 4C. A first content update (510) that includes text generated based on the computer-mediated interaction has been inserted after the fourth point in the instruction. The first content update includes text content “If you do not see the “save to device” menu . . . ” and “Request the file owner to grant you access . . . ” that is generated based on the identified information.

The modified content item 500 further includes a second content update 512. The second content update 512 is a screenshot that illustrates an example of the user interface that the user may see when the file locking feature has been enabled. As can be seen, the menu 514 is different from the menu 426 (the “save to device” option is absent) since the locking feature enabled for “File 1” makes it unavailable for download.

Second content update 512 may be generated in a variety of ways. In some implementations, the computer-mediated interaction may include a visual and/or video shared by the customer service agent. Such visual and/or video may be utilized as the second update, with suitable transformation (e.g., to replace filenames with generic names). In some implementations, a generative technique (e.g., a generative artificial intelligence model) may be applied that takes as input the codebase and/or user interface assets for the software product (with reference to which the computer-mediated interaction takes place) and the identified information as input and automatically generates the second content update. Audio updates may be generated similarly. Second content update 512 is inserted at a different insertion point (close to the screenshot 424) than the first content update.

While FIG. 5 shows both a text and a visual content update being inserted into content item 420 to obtain modified content item 500, in various implementations, one or more of text, audio, image, or video content updates may be generated and included in the modified content item. While the foregoing discussion refers to an existing content item being modified, in some implementations, a new content item may be generated based on the identified information. In these implementations, modifying the existing content item may include adding a link to the new content item. In some implementations, more than one existing content item may be updated to link to the new content item. For example, based on recognizing the “lock feature” and associated changes to menu options, a new content item that describes the feature as available for OS A, OS B, OS C, and OS D may be generated and the corresponding content item (400-420, which may be different sections of the same content item, or may be different content items) may be updated to include a link to the generated content item.

In some implementations, method 200 may further include displaying the content update to the customer service agent. For example, the content item generated after a successful interaction may be presented to the customer service agent for editing and/or approval. In these implementations, the method may further include receiving confirmation of the content update from the customer service agent. The confirmation may include edits to the content update made by the customer service agent. In these implementations, modifying the content item is performed in response to receiving the confirmation. If no confirmation is received (e.g., the customer service agent rejects the generated content item), the content item is not modified. Further, a record of rejection may be maintained and utilized to automatically discard future content updates that are similar to the generated update. The feedback from a customer service agent (or other person that edits/approves the content item) may be utilized as training data in the reinforcement learning from human feedback (RLHF) loop to update the machine learning model that generates the content update.

In some implementations, method 200 may further include determining that the information provided by the customer service agent during the computer-mediated interaction is from a different content item (e.g., a third content item distinct from the content item with reference to which the interaction takes place). In these implementations, generating the content update may include merging the content item with the third content item, inserting a link to the third content item in the content item, or replacing a portion of the content item with a portion of the third content item.

Various blocks of method 200 may be combined, split into multiple blocks, or be performed in parallel. Method 200, or portions thereof, may be repeated any number of times using additional inputs. For example, method 200 may be repeated for different computer-mediated interactions.

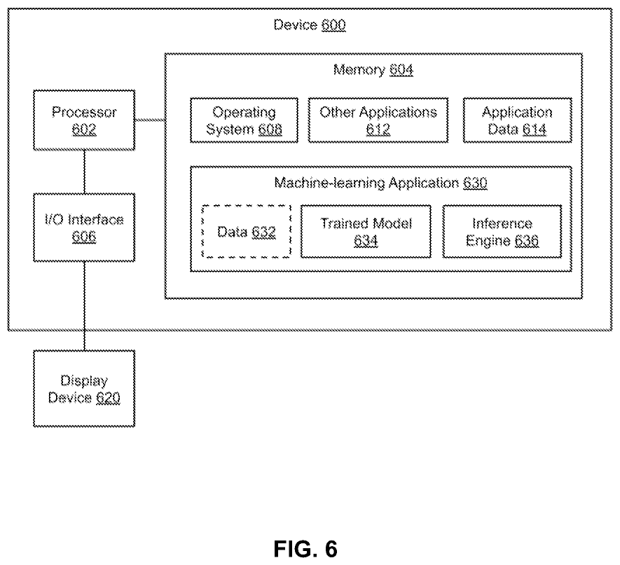

FIG. 6 is a block diagram of an example device 600 which may be used to implement one or more features described herein. In one example, device 600 may be used to implement a client device, e.g., any of client devices 115 shown in FIG. 1. Alternatively, device 600 can implement a server device, e.g., server 101. In some implementations, device 600 may be used to implement a client device, a server device, or both client and server devices. Device 600 can be any suitable computer system, server, or other electronic or hardware device as described above.

One or more methods described herein can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 600 includes a processor 602, a memory 604, and input/output (I/O) interface 606. Processor 602 can be one or more processors and/or processing circuits to execute program code and control basic operations of the device 600. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some implementations, processor 602 may include one or more co-processors that implement neural-network processing. In some implementations, processor 602 may be a processor that processes data to produce probabilistic output, e.g., the output produced by processor 602 may be imprecise or may be accurate within a range from an expected output. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 604 is typically provided in device 600 for access by the processor 602, and may be any suitable processor-readable storage medium, such as random access memory (RAM), read-only memory (ROM), Electrical Erasable Read-only Memory (EEPROM), Flash memory, etc., suitable for storing instructions for execution by the processor, and located separate from processor 602 and/or integrated therewith. Memory 604 can store software operating on the server device 600 by the processor 602, including an operating system 608, machine-learning application 630, other applications 612, and application data 614. Other applications 612 may include applications such as a data display engine, web hosting engine, image display engine, notification engine, social networking engine, etc. In some implementations, the machine-learning application 630 and other applications 612 can each include instructions that enable processor 602 to perform functions described herein, e.g., some or all of the method of FIG. 2.

Other applications 612 can include, e.g., image editing applications, media display applications, communication applications, web hosting engines or applications, mapping applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application may utilize Bayesian classifiers, support vector machines, neural networks, or other learning techniques. In some implementations, machine-learning application 630 may include a trained model 634, an inference engine 636, and data 632. In some implementations, data 632 may include training data, e.g., data used to generate trained model 634. For example, training data may include any type of data such as text, images, audio, video, etc.

Training data may be obtained from any source, e.g., a data repository specifically marked for training, data for which permission is provided for use as training data for machine-learning, etc. In implementations where one or more users permit use of their respective user data to train a machine-learning model, e.g., trained model 634, training data may include such user data. In implementations where users permit use of their respective user data, data 632 may include permitted data such as images (e.g., photos or other user-generated images).

In some implementations, training data may include synthetic data generated for the purpose of training, such as data that is not based on user input or activity in the context that is being trained, e.g., data generated from simulated photographs or other computer-generated images. In some implementations, machine-learning application 630 excludes data 632. For example, in these implementations, the trained model 634 may be generated, e.g., on a different device, and be provided as part of machine-learning application 630. In various implementations, the trained model 634 may be provided as a data file that includes a model structure or form, and associated weights. Inference engine 636 may read the data file for trained model 634 and implement a neural network with node connectivity, layers, and weights based on the model structure or form specified in trained model 634.

In some implementations, the trained model 634 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc. The model form or structure may specify connectivity between various nodes and organization of nodes into layers.

For example, the nodes of a first layer (e.g., input layer) may receive data as input data 632 or application data 614. Such data can include, for example, one or more pixels per node, e.g., when the trained model is used for image analysis or image generation. Subsequent intermediate layers may receive as input output of nodes of a previous layer per the connectivity specified in the model form or structure. These layers may also be referred to as hidden layers or latent layers. A final layer (e.g., output layer) produces an output of the machine-learning application. In some implementations, model form or structure also specifies a number and/or type of nodes in each layer.

In different implementations, trained model 634 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 634 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 632, to produce a result.

For example, training may include applying supervised learning techniques. In supervised learning, the training data can include a plurality of inputs (e.g., a set of grayscale images) and a corresponding expected output for each input (e.g., a set of groundtruth images corresponding to the grayscale images or other color images). Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner.

In some implementations, unsupervised learning may be used to produce knowledge representations, e.g., that may be used by machine-learning application 630. For example, unsupervised learning may be used to produce embeddings that are utilized by pixel discriminator 222, as described above with reference to FIGS. 2 and 4. In various implementations, a trained model includes a set of weights, or embeddings, corresponding to the model structure. In implementations where data 632 is omitted, machine-learning application 630 may include trained model 634 that is based on prior training, e.g., by a developer of the machine-learning application 630, by a third-party, etc. In some implementations, trained model 634 may include a set of weights that are fixed, e.g., downloaded from a server that provides the weights.

Machine-learning application 630 also includes an inference engine 636. Inference engine 636 is configured to apply the trained model 634 to data, such as application data 614, to provide an inference. In some implementations, inference engine 636 may include software code to be executed by processor 602. In some implementations, inference engine 636 may specify circuit configuration (e.g., for a programmable processor, for a field programmable gate array (FPGA), etc.) enabling processor 602 to apply the trained model. In some implementations, inference engine 636 may include software instructions, hardware instructions, or a combination. In some implementations, inference engine 636 may offer an application programming interface (API) that can be used by operating system 608 and/or other applications 612 to invoke inference engine 636, e.g., to apply trained model 634 to application data 614 to generate an inference.

Machine-learning application 630 may provide several technical advantages. For example, when trained model 634 is generated based on unsupervised learning, trained model 634 can be applied by inference engine 636 to produce knowledge representations (e.g., numeric representations) from input data, e.g., application data 614. For example, a model trained for image analysis may produce representations of images that have a smaller data size (e.g., 1 KB) than input images (e.g., 10 MB). In some implementations, such representations may be helpful to reduce processing cost (e.g., computational cost, memory usage, etc.) to generate an output (e.g., a label, a classification, a sentence descriptive of the image, a colorized image from a grayscale image, etc.).

In some implementations, such representations may be provided as input to a different machine-learning application that produces output from the output of inference engine 636. In some implementations, knowledge representations generated by machine-learning application 630 may be provided to a different device that conducts further processing, e.g., over a network. In such implementations, providing the knowledge representations rather than the images may provide a technical benefit, e.g., enable faster data transmission with reduced cost. In another example, a model trained for clustering documents may produce document clusters from input documents. The document clusters may be suitable for further processing (e.g., determining whether a document is related to a topic, determining a classification category for the document, etc.) without the need to access the original document, and therefore, save computational cost.

In some implementations, machine-learning application 630 may be implemented in an offline manner. In these implementations, trained model 634 may be generated in a first stage, and provided as part of machine-learning application 630. In some implementations, machine-learning application 630 may be implemented in an online manner. For example, in such implementations, an application that invokes machine-learning application 630 (e.g., operating system 608, one or more of other applications 612) may utilize an inference produced by machine-learning application 630, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 634, e.g., to update embeddings for trained model 634.

In some implementations, machine-learning application 630 may be implemented in a manner that can adapt to particular configuration of device 600 on which the machine-learning application 630 is executed. For example, machine-learning application 630 may determine a computational graph that utilizes available computational resources, e.g., processor 602. For example, if machine-learning application 630 is implemented as a distributed application on multiple devices, machine-learning application 630 may determine computations to be carried out on individual devices in a manner that optimizes computation. In another example, machine-learning application 630 may determine that processor 602 includes a GPU with a particular number of GPU cores (e.g., 1000) and implement the inference engine accordingly (e.g., as 1000 individual processes or threads).

In some implementations, machine-learning application 630 may implement an ensemble of trained models. For example, trained model 634 may include a plurality of trained models that are each applicable to same input data. In these implementations, machine-learning application 630 may choose a particular trained model, e.g., based on available computational resources, success rate with prior inferences, etc. In some implementations, machine-learning application 630 may execute inference engine 636 such that a plurality of trained models is applied. In these implementations, machine-learning application 630 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 608 or one or more applications 612.

In different implementations, machine-learning application 630 can produce different types of outputs. For example, machine-learning application 630 can provide representations or clusters (e.g., numeric representations of input data), labels (e.g., for input data that includes images, documents, etc.), phrases or sentences (e.g., descriptive of an image or video, suitable for use as a response to an input sentence, etc.), images (e.g., colorized or otherwise stylized images generated by the machine-learning application in response to input images, e.g., grayscale images), audio or video (e.g., in response an input video, machine-learning application 630 may produce an output video with a particular effect applied, e.g., rendered in a comic-book or particular artist's style, when trained model 634 is trained using training data from the comic book or particular artist, etc. In some implementations, machine-learning application 630 may produce an output based on a format specified by an invoking application, e.g., operating system 608 or one or more applications 612. In some implementations, an invoking application may be another machine-learning application. For example, such configurations may be used in generative adversarial networks, where an invoking machine-learning application is trained using output from machine-learning application 630 and vice-versa.

Any of software in memory 604 can alternatively be stored on any other suitable storage location or computer-readable medium. In addition, memory 604 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 604 and any other type of storage (magnetic disk, optical disk, magnetic tape, or other tangible media) can be considered “storage” or “storage devices.”

I/O interface 606 can provide functions to enable interfacing the server device 600 with other systems and devices. Interfaced devices can be included as part of the device 600 or can be separate and communicate with the device 600. For example, network communication devices, storage devices (e.g., memory and/or database 106), and input/output devices can communicate via I/O interface 606. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 606 can include one or more display devices 620 that can be used to display content, e.g., images, video, and/or a user interface of an output application as described herein. Display device 620 can be connected to device 600 via local connections (e.g., display bus) and/or via networked connections and can be any suitable display device. Display device 620 can include any suitable display device such as an LCD, LED, or plasma display screen, CRT, television, monitor, touchscreen, 3-D display screen, or other visual display device. For example, display device 620 can be a flat display screen provided on a mobile device, multiple display screens provided in a goggles or headset device, or a monitor screen for a computer device.

The I/O interface 606 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 6 shows one block for each of processor 602, memory 604, I/O interface 606, and software blocks 608, 612, and 630. These blocks may represent one or more processors or processing circuitries, operating systems, memories, I/O interfaces, applications, and/or software modules. In other implementations, device 600 may not have all of the components shown and/or may have other elements including other types of elements instead of, or in addition to, those shown herein. While some components are described as performing blocks and operations as described in some implementations herein, any suitable component or combination of components of environment 100, device 600, similar systems, or any suitable processor or processors associated with such a system, may perform the blocks and operations described.

Methods described herein can be implemented by computer program instructions or code, which can be executed on a computer. For example, the code can be implemented by one or more digital processors (e.g., microprocessors or other processing circuitry) and can be stored on a computer program product including a non-transitory computer readable medium (e.g., storage medium), such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

Although the description has been described with respect to particular implementations thereof, these particular implementations are merely illustrative, and not restrictive. Concepts illustrated in the examples may be applied to other examples and implementations.

In situations in which certain implementations discussed herein may collect or use personal information about users (e.g., user data, information about a user's social network, user's location and time at the location, user's biometric information, user's activities and demographic information), users are provided with one or more opportunities to control whether information is collected, whether the personal information is stored, whether the personal information is used, and how the information is collected about the user, stored and used. That is, the systems and methods discussed herein collect, store and/or use user personal information specifically upon receiving explicit authorization from the relevant users to do so. For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user device's geographic location may be generalized to a larger region so that the user's particular location cannot be determined.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method to automatically modify a content item, comprising:
programmatically analyzing computer-mediated interaction between a user and a customer service agent to determine if the computer-mediated interaction is successful, wherein the computer-mediated interaction is with reference to the content item;
identifying information provided by the customer service agent during the computer-mediated interaction;
generating a content update based on the identified information; and
modifying the content item based on the content update.

2. The computer-implemented method of claim 1, wherein the programmatically analyzing is performed in response to determining that a rating associated with the content item is below a threshold.

3. The computer-implemented method of claim 2, wherein determining that the rating associated with the content item is below the threshold comprises determining that a contact rate of customers to a customer service center for support after views of the content item by the customers is higher than a predetermined rate.

4. The computer-implemented method of claim 1, wherein the computer-mediated interaction includes one or more of: a call, a synchronous chat, or asynchronous interaction.

5. The computer-implemented method of claim 1, wherein the programmatically analyzing includes detecting a user sentiment during the computer-mediated interaction based on one or more of: text, speech, or video of the user.

6. The computer-implemented method of claim 4, wherein the interaction is successful if the user sentiment at an endpoint of the computer-mediated interaction meets a threshold, and wherein identifying information provided by the customer service agent comprises identifying a subset of text, speech, or video of the customer service agent near a time during the computer-mediated interaction at which the user sentiment changes from below the threshold to above the threshold.

7. The computer-implemented method of claim 5, wherein the subset of text, speech, or video includes a link to a second content item, and wherein generating the content update includes generating text with the link to the second content item, and wherein modifying the content item comprises inserting the text with the link to the second content item in the content item.

8. The computer-implemented method of claim 1, wherein the content item includes one or more of item text, item audio, or item video, and wherein modifying the content item comprises determining an insertion point for the additional content.

9. The computer-implemented method of claim 1, wherein the content item is a help article and wherein the computer-mediated interaction is with reference to a user interface of a software product, wherein information provided by the customer service agent includes a screenshot or a video of the user interface of the software product, and wherein the content update comprises the screenshot or the video.

10. The computer-implemented method of claim 1, further comprising:
displaying the content update to the customer service agent; and
receiving confirmation of the content update from the customer service agent, wherein modifying the content item is performed in response to receiving the confirmation.

11. The computer-implemented method of claim 1, further comprising:
determining that the information provided by the customer service agent during the computer-mediated interaction is from a third content item, and
wherein generating the content update comprises one or more of: merging the content item with the third content item, inserting a link to the third content item in the content item, or replacing a portion of the content item with a portion of the third content item.

12. A computing device comprising:
a processor; and
a memory coupled to the processor, with instructions stored thereon that, when executed by the processor, cause the processor to perform operations comprising:
programmatically analyzing computer-mediated interaction between a user and a customer service agent to determine if the computer-mediated interaction is successful, wherein the computer-mediated interaction is with reference to a content item;
identifying information provided by the customer service agent during the computer-mediated interaction;
generating a content update based on the identified information; and
modifying the content item based on the content update.

13. The computing device of claim 12, wherein the programmatically analyzing is performed in response to determining that a rating associated with the content item is below a threshold.

14. The computing device of claim 12, wherein determining that the rating associated with the content item is below the threshold comprises determining that a contact rate of customers to a customer service center for support after views of the content item by the customers is higher than a predetermined rate.

15. The computing device of claim 12, wherein the programmatically analyzing includes detecting a user sentiment during the computer-mediated interaction based on one or more of: text, speech, or video of the user.

16. The computing device of claim 12, wherein the memory has further instructions stored thereon that cause the processor to perform further operations comprising:
displaying the content update to the customer service agent; and
receiving confirmation of the content update from the customer service agent, wherein modifying the content item is performed in response to receiving the confirmation.

17. A non-transitory computer-readable medium with instructions stored thereon that, when executed by a processor, cause the processor to perform operations comprising:
programmatically analyzing computer-mediated interaction between a user and a customer service agent to determine if the computer-mediated interaction is successful, wherein the computer-mediated interaction is with reference to a content item;
identifying information provided by the customer service agent during the computer-mediated interaction;
generating a content update based on the identified information; and
modifying the content item based on the content update.

18. The non-transitory computer-readable medium of claim 17, wherein the programmatically analyzing is performed in response to determining that a rating associated with the content item is below a threshold.

19. The non-transitory computer-readable medium of claim 17, wherein determining that the rating associated with the content item is below the threshold comprises determining that a contact rate of customers to a customer service center for support after views of the content item by the customers is higher than a predetermined rate.

20. The non-transitory computer-readable medium of claim 17, wherein the programmatically analyzing includes detecting a user sentiment during the computer-mediated interaction based on one or more of: text, speech, or video of the user.
